(19) United States
(12) Patent Application Publication
(10) Pub. No.: US 2023/0239703 A1
(43) Pub. Date: Jul. 27, 2023

(54) MULTIPLE CHANNEL COMMUNICATION IN UNLICENSED SPECTRUM

(71) Applicant: Nokia Technologies Oy, Espoo (FI)

(72) Inventors: Claudio Rosa, Randers (DK); Morten Toft, Svenstrup (DK); Olli Alanen, Vantaa (FI); Mika Kasslin, Espoo (FI)

(73) Assignee: Nokia Technologies Oy, Espoo (FI)

(21) Appl. No.: 18/007,977

(22) PCT Filed: Jun. 4, 2020
(86) PCT No.: PCT/EP2020/065530

§ 371 Date: Dec. 2, 2022

(51) Int. Cl. H04W 16/14; H04W 74/08

(52) U.S. Cl. CPC H04W 16/14; H04W 74/0816

(57) ABSTRACT

A method and apparatus for communicating on multiple channels, perhaps in data duplication communications in unlicensed spectrum. The method comprises scanning a plurality of channels in unlicensed spectrum to determine whether the plurality of channels are available. In response to determining at least one of the channels is available determining when a transmitting opportunity may occur and estimating at least one delay between said transmitting opportunity and at least one further transmitting opportunity at which it is estimated that the apparatus may be able to transmit a signal on at least one other of said multiple channels. Determining hether any of said at least one delays lie within a current deferral allowance and where not transmitting the signal on the available hannel; and where so delaying transmitting the signal until a further transmitting opportunity within the current deferral allowance.

### TECHNOLOGICAL FIELD

Various example embodiments relate to communications within unlicensed spectrum.

### BACKGROUND

The unlicensed spectrum provides an opportunity to increase the bandwidth available for signals to be transmitted. However, as this bandwidth is shared with other devices some scanning of the channel may be needed prior to transmission to reduce interference. Furthermore, there may be rules regarding how often a device can scan a channel to allow the spectrum to be fairly shared and these issues can lead to increased latency.

The unlicensed band is divided into sub-bands or channels each covering a certain frequency band and scanning procedures such as listen before talk involves the sensing of these channels to determine whether they are available prior to transmitting a signal. Where a channel is available the channel may be acquired by the device for a channel occupancy time COT. During this time signals may be transmitted and other devices are deterred from using the channel.

Devices are increasingly being able to transmit and receive on multiple channels. This ability may be used in conjunction with data duplication on different sub-channels to increase the reliability of transmissions. When transmitting on multiple channels, it is required for the transmitter to scan each channel separately prior to transmission. Where the channels are close in the frequency band a channel cannot be scanned while a transmission is occurring. Thus, in some cases it may be desirable to wait for multiple channels to be available prior to transmitting, however, if one of the channels is blocked then this can significantly increase latency.

It would be desirable to provide a system for communicating in the unlicensed spectrum in a manner which is both efficient and has some control on latency.

### BRIEF SUMMARY

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to various, but not necessarily all, embodiments of the invention there is provided according to a first aspect an apparatus comprising means configured to:
initiate scanning of a plurality of channels in unlicensed spectrum to determine whether said plurality of channels are available;
determine a transmitting opportunity at which said apparatus is able to transmit a signal on at least one channel sensed to be available during said scanning;
estimate at least one further transmitting opportunity when it is estimated that said apparatus may be able to transmit a signal on at least one other channel in unlicensed spectrum; and
ascertain whether a delay between said transmitting opportunity and said at least one further transmitting opportunity lies within a current deferral allowance for said apparatus; and where not
   control transmission of a signal on said at least one available channel; and where so
   wait for one of said at least one further transmitting opportunities that lie within said current deferral allowance before controlling transmission of at least one signal on said at least one available channel.

Embodiments seek to address the competing issues, each of which may potentially increase latency, that arise when seeking to transmit signals on different channels of the unlicensed spectrum. Where a first signal is transmitted at a first transmitting opportunity when a channel is sensed as being available, scanning to determine the availability of other channels during the transmission period is impeded. Where the apparatus waits before transmitting the first signal for one or more further channels to become available the apparatus risks an undue delay before any signal is transmitted if a further channel does not become available for a while. These problems have been addressed by the apparatus being configured such that the decision to transmit or wait is an informed decision that takes account of different factors. Thus, the apparatus has a deferral allowance which is a delay period in transmitting the signal that may have been set to be at a level that is deemed to be acceptable for certain required latency. This may be set as a time period or as a counter value, the counter value indicating a number of transmission opportunities for example. The apparatus is configured to estimate whether a further channel is likely to become available or it is possible that it may do so at a future transmission opportunity within the deferral allowance. If the apparatus estimates this to be the case, then the apparatus delays transmission until a subsequent transmission opportunity where it then makes the same assessment. Where it estimates that there will be no channel available within the deferral allowance then it transmits a signal on the channel(s) that is available. In this way whether to defer transmission or not is based on an assessment as to whether or not it is likely that there will be an opportunity to transmit on a further channel within the deferral period and as soon as it is determined that this is not the case, then transmission occurs on the available channel(s) at the next transmitting opportunity. In this way there is an increased likelihood that more than one channel may be used to transmit a signal compared to an apparatus that does not defer, while the increase in latency that arises due to waiting for a further channel is managed to be within certain limits and is only used where such a wait may yield an available additional channel.

It should be noted that where the term channel is used, this denotes a frequency band in unlicensed spectrum that is used for the transmission of signals to other devices, the scanning procedure determining the availability of this frequency band. It may in the description of embodiments on occasion be termed a sub-channel, link or sub band.

In some embodiments, said means is configured to estimate a time of said at least one further transmitting opportunity for said at least one channel from at least one of: a determined status of said channel and a backoff time associated with said channel, said backoff time being a minimum time delay before a transmitting opportunity can occur if said channel is currently and remains idle.

The apparatus may determine whether it is likely that there will be a transmitting opportunity within the deferral allowance from a number of factors, and in some cases it may determine this from the determined status of the channel, that is whether it is available or idle for example and/or from a backoff time associated with the channel. The backoff time is a minimum time delay before a transmitting opportunity can occur if a channel is currently and remains idle. Each of these factors affect whether or not a channel will be available at a subsequent transmitting opportunity and can be used by the apparatus to determine whether waiting for such a channel is something that may improve performance.

In some embodiments, said determined status of said channel comprises one of: a sensed status sensed during a previous measurement time period, or an estimated status based on said sensed status and historical availability of said channel.

When making the estimation the status of the channel is important and its current status may not be known, but it may be determined either from the status sensed at a previous measurement time period or from a historical availability of the channel from which its likely status may be estimated, or from a combination of a previous measurement and historical availability.

In some embodiments, said previous measurement time period comprises a measurement period immediately preceding a most recent transmitting opportunity.

The more recent the sensed status is the more likely it is to be accurate, thus, where the sensed status is the status sensed in the immediately preceding measurement time then this may provide a more accurate estimation.

In some embodiments, said means is configured to determine if any of said at least one other of said multiple channels is available at one of said at least one further transmitting opportunities and where so said means is configured to control transmitting said at least one signal on said at least one available channel and at least one further signal on said at least one other available channel at said one of said at least one further transmitting opportunities.

If the apparatus does defer transmission and scans the other channels, where channels are detected to be available then signals may be transmitted both on the first channel that was sensed to be available and on any other channels that are sensed to be available at the next transmitting opportunity. In this way, multiple channels are used for transmitting one or more signals and the reliability and/or bandwidth of transmission is increased.

In some embodiments, said means is configured to determine whether all of said at least one other of said multiple channels are busy and where so to control transmission of said at least one signal on said at least one available channel at a next transmitting opportunity.

Where the scanning of the other channels determines that they are all busy then it may be that none of the channels will be available within the deferral allowance and the apparatus may then make the decision to transmit the signal on the available channel.

In this way, there is not unnecessary delay in transmitting the signal while waiting for channels that will not become available.

In some embodiments, said at least one signal and said at least one further signal are a same signal, said apparatus being configured to transmit duplicate signals on multiple channels.

Embodiments may be particularly effective at transmitting duplicate signals on different channels and thereby improving the reliability of a transmission. Where duplicate signals are to be transmitted then allowing them to be transmitted simultaneously on multiple channels is a very effective way of increasing reliability. If one signal is transmitted on one channel then there is a delay before a subsequent channel can be scanned and latency is increased or where the signal is not duplicated reliability is decreased. Embodiments increase the chances of signals being able to be transmitted simultaneously on multiple channels while managing the increase in latency that a blocked channel might introduce.

In some embodiments, said apparatus comprises a user equipment, while in other embodiments, said apparatus comprises a gNB.

User equipment transmitting signals to each other may do so using this technique. Similarly a gNB which corresponds to a base station in 5G may use this technique to transmit signals to one or more devices such as user equipment.

In some embodiments, said one or more signals comprise uplink signals. This may be the case for example where the apparatus is a user equipment.

In some embodiments the deferral allowance may be set centrally by the network and the apparatus may be configured to receive an indication of the deferral allowance from a network node and to set the deferral allowance accordingly. The network node may transmit signals indicating the deferral allowance that is to be used. In some embodiments the network node may also transmit further signals indicating that data duplication is to be used, and that a certain listen before talk scanning procedure is to be used.

In other embodiments, said one or more signals comprise downlink signals which may be the case where apparatus is a gNB.

In some embodiments, the means comprise:

at least one processor; and
at least one memory including computer program code, said at least one memory and computer program code being configured to, with said at least one processor, cause the performance of the apparatus.

In some embodiments, said apparatus further comprises means for transmitting and receiving signals, and means for scanning channels in unlicensed spectrum.

According to various, but not necessarily all, embodiments of the invention there is provided according to a second aspect a method comprising:
scanning a plurality of channels in unlicensed spectrum to determine whether said plurality of channels are available;
in response to determining at least one of said plurality of channels is available determining a transmitting opportunity at which said apparatus is able to transmit at least one signal on said at least one available channel;
estimating at least one delay between said transmitting opportunity and at least one further transmitting opportunity at which it is estimated that said apparatus may be able to transmit a signal on at least one other of said plurality of channels; and
determining whether any of said at least one delays lie within a current deferral allowance and where not
   transmitting said at least one signal on said at least one available channel; and.
where so
   delaying transmitting said at least one signal on said at last one available channel until a further transmitting opportunity within said current deferral allowance.

In some embodiments, said step of estimating said at least one delay comprises estimating a time of said at least one further transmitting opportunity for said at least one channel from at least one of: a determined status of said channel and a backoff time associated with said channel, said backoff time being a minimum time delay before a transmitting opportunity can occur if said channel is currently and remains idle. a determined status of said channel.

In some embodiments, said determined status of said channel comprises one of: a sensed status sensed during a previous measurement time period, or an estimated status based on said sensed status and historical availability of said channel.

In some embodiments, said method further comprises determining if any of said at least one other of said plurality of channels is available at one of said at least one further transmitting opportunities and where so
controlling said transmitting means to transmit said at least one signal on said at least one available channel and said at least one further signal on said at least one other available channel at said further transmitting opportunity.

In some embodiments, said method comprises determining whether all of said at least one other of said plurality of channels are busy and where so controlling said transmitting means to transmit said at least one signal on said at least one available channel at a next transmitting opportunity.

In some embodiments, said at least one signal and said at least one further signal are a same signal, said method transmitting duplicate signals on multiple channels where multiple channels are available.

According to various, but not necessarily all, embodiments of the invention there is provided according to a third aspect a computer program comprising computer readable instructions which when executed by a processor on an apparatus are operable to control said apparatus to perform a method according to a second aspect.

According to various, but not necessarily all, embodiments of the invention there is provided an apparatus comprising: scanning circuitry configured to scan multiple channels in unlicensed spectrum to determine whether said channels are available; a transmitter for transmitting one or more signals on one or more of said multiple channels; and control circuitry for controlling transmission of said one or more signals, said control circuitry being configured to initiate said scanning circuitry to scan a plurality of said multiple channels to determine whether said plurality of channels are available; to determine a transmitting opportunity at which said apparatus is able to transmit a signal on at least one channel sensed to be available by said scanning circuitry; to estimate at least one further transmitting opportunity when it is estimated that said apparatus may be able to transmit a signal on at least one other of said multiple channels; and to ascertain whether a delay between said transmitting opportunity and said at least one further transmitting opportunity lies within a deferral allowance for said apparatus; and where not to control said transmitter to transmit a signal on said at least one available channel; and where so to wait for one of said at least one further transmitting opportunities that lie within said deferral allowance before controlling said transmitted to transmit at least one signal on said at least one available channel.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

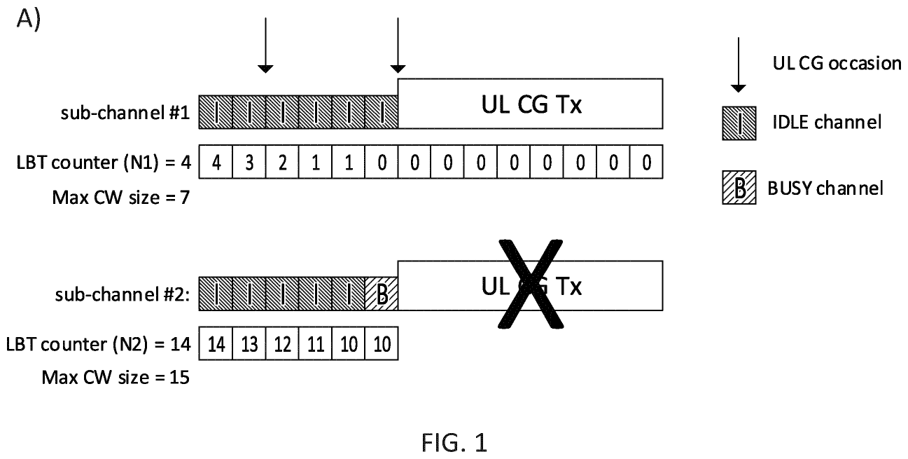

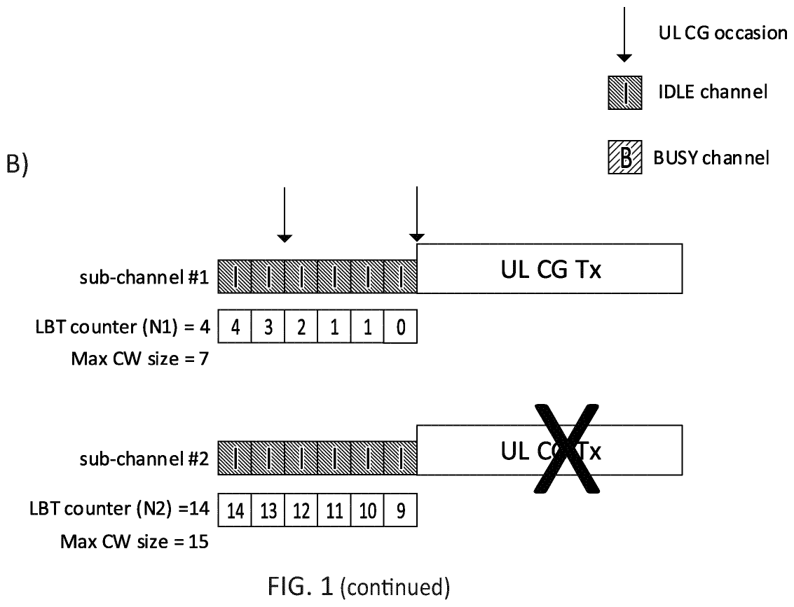

FIG. 1 illustrates examples of transmitting duplicate signals on two sub-channels where self deferral is not used, with and without interference, type A1 LBT procedure without self deferral;

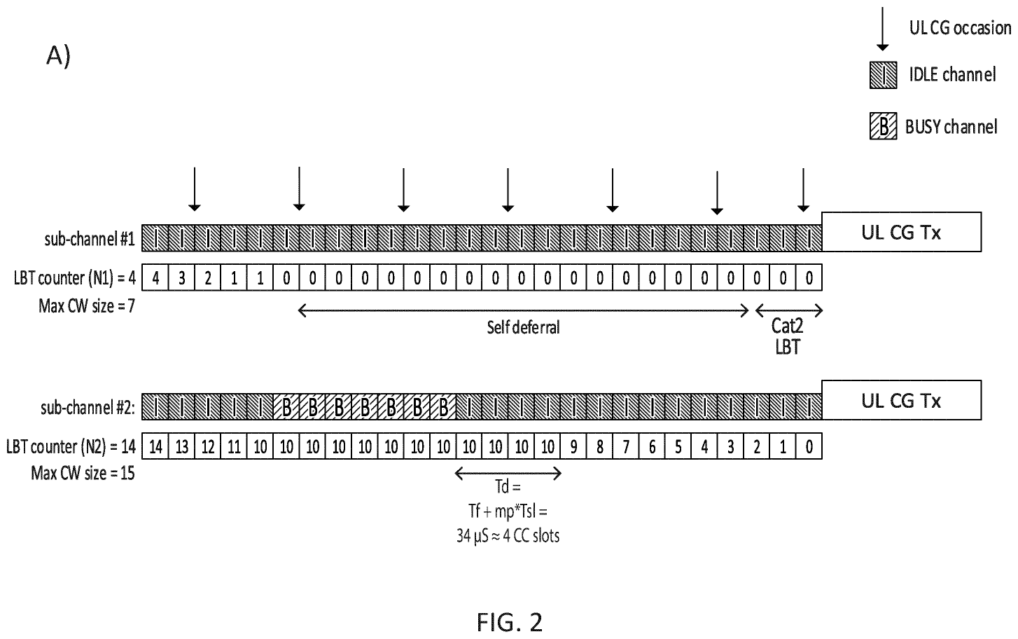

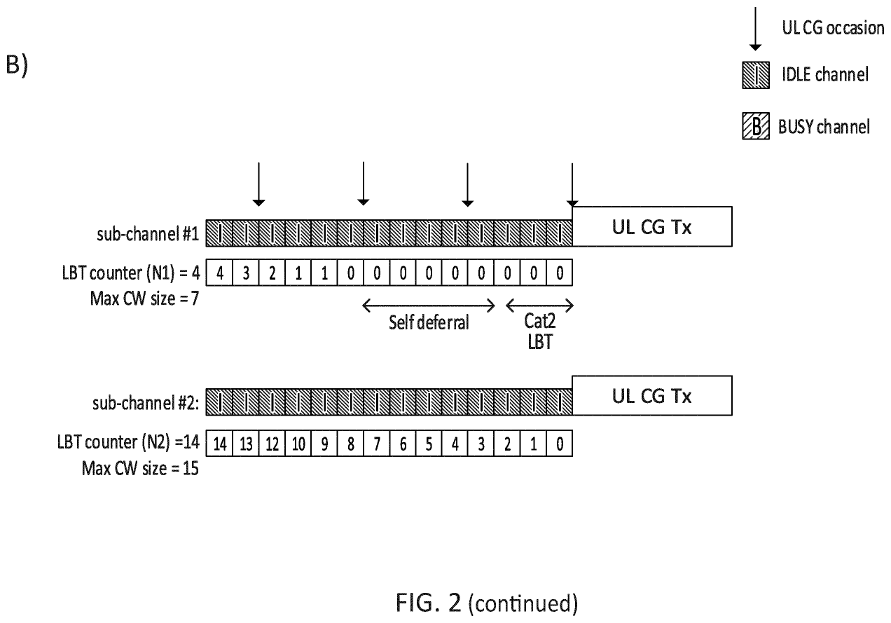

FIG. 2 illustrates examples of transmitting duplicate signals on two sub-channels where self deferral is used, with and without interference, type A1 LBT procedure with self deferral;

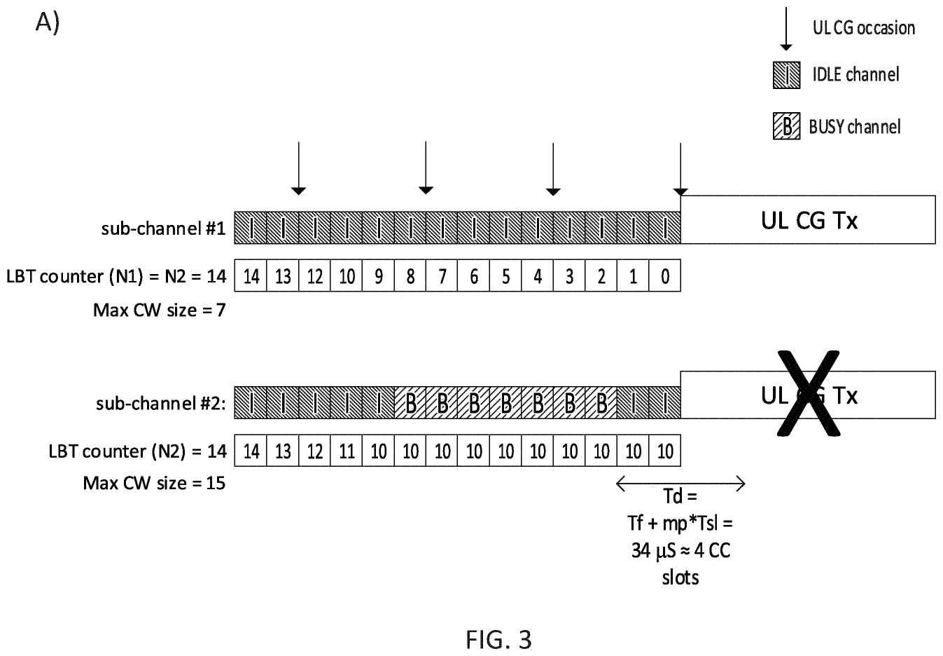

FIG. 3 illustrates examples of transmitting duplicate signals on two sub-channels with and without interference, type A2 LBT procedure;

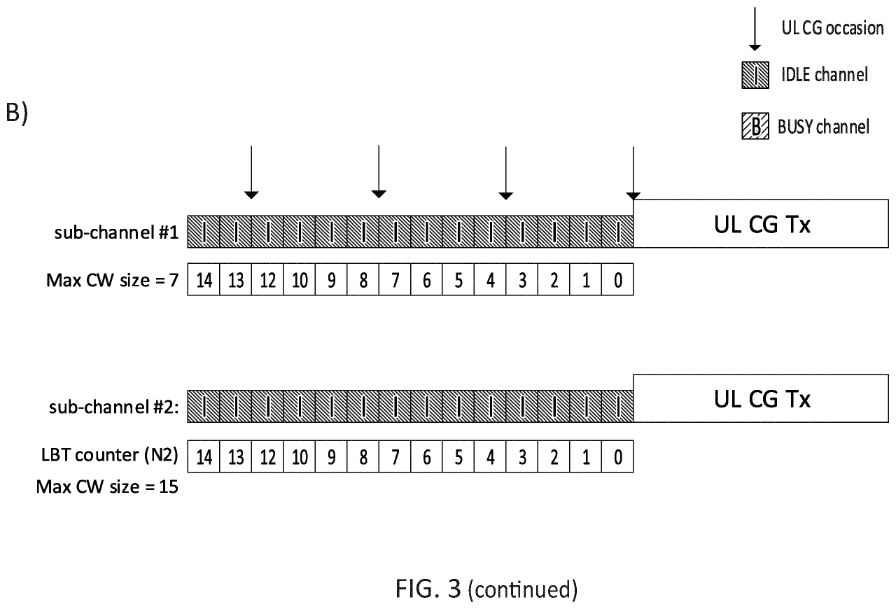

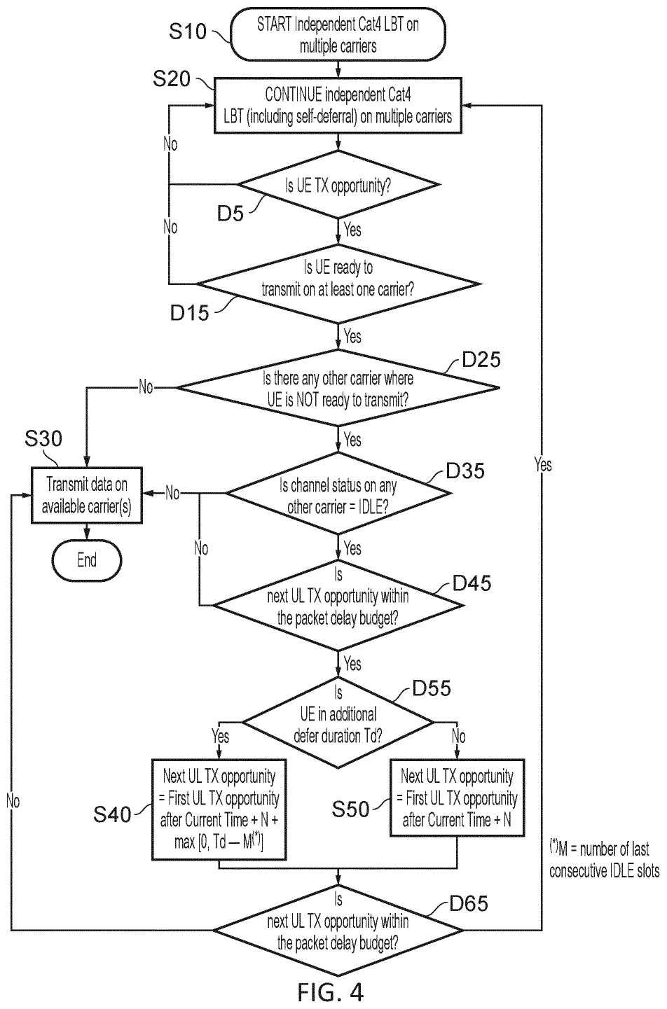

FIG. 4 shows a flow diagram illustrating steps in a method according to an example embodiment;

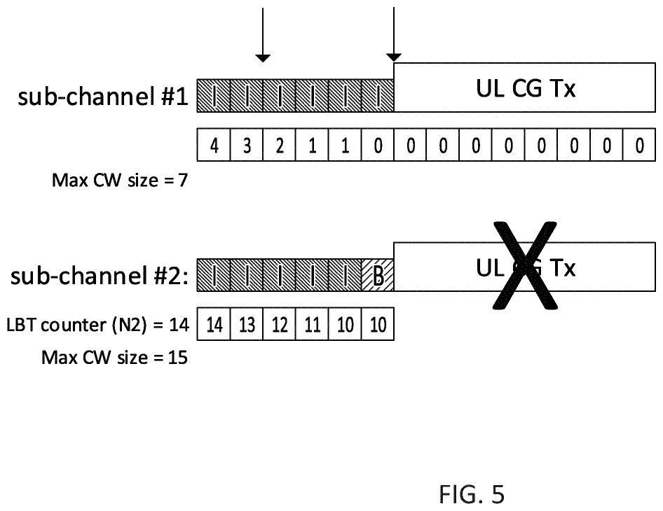

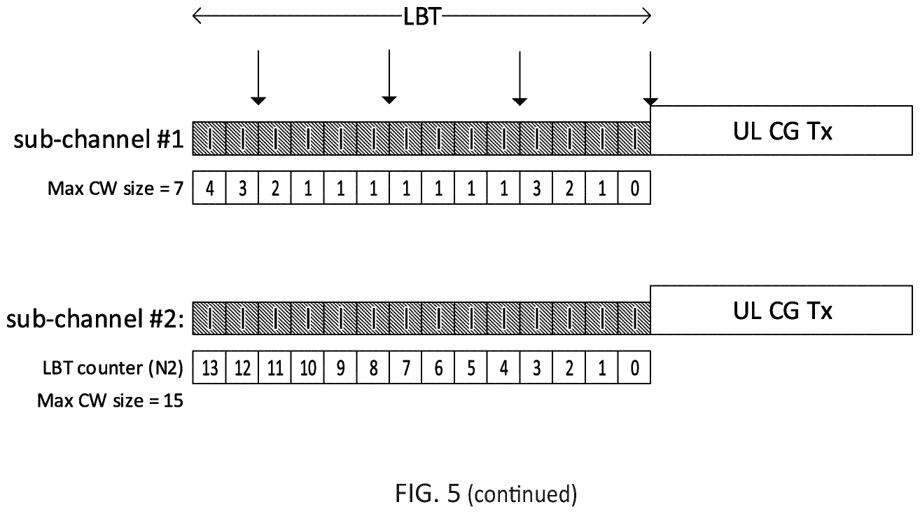

FIG. 5 illustrates an example of transmitting duplicate signals on two sub-channels using a method according to an embodiment with and without interference on one of the sub-channels; and

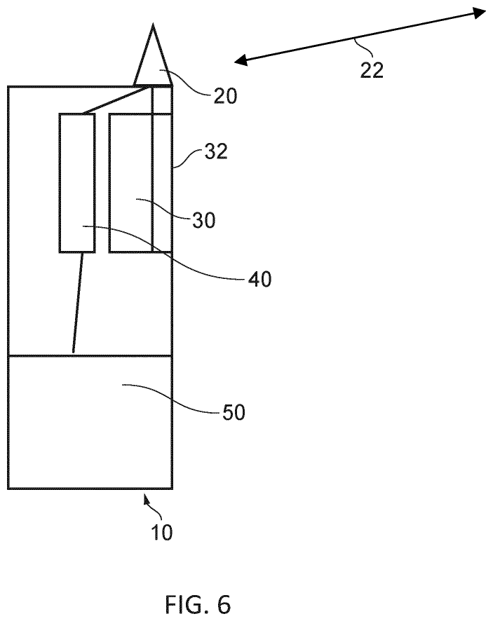

FIG. 6 schematically shows an apparatus according to an embodiment.

### DETAILED DESCRIPTION

Before discussing the example embodiments in any more detail, first an overview will be provided.

Increasingly devices are able to transmit and receive on more than one channel and this ability may be used to improve the spectral efficiency and/or increase the reliability of transmissions, by for example transmitting duplicate data on more than one channel. However, where signals are transmitted in unlicensed spectrum as this bandwidth is shared with other devices some scanning of the channel may be required prior to any transmission to determine if a channel is available. Thus, although it may be advantageous to transmit a signal on more than one channel, where the channels being used are relatively close in the frequency spectrum, then a device will be impeded from scanning one of the channels while transmitting on the other. For the above reasons it may be advantageous when transmitting on more than one channel in the unlicensed spectrum to transmit at the same time on the multiple channels. However, in order to do this it must first be ascertained that both channels are currently available and this requirement to wait for the availability of more than one channel can lead to increased latency. In particular, if one channel is sensed not to be available while another is, then a decision must be made as to whether to wait for both channels or to transmit on the available channel, choosing the latter means that the other channel cannot be scanned until the transmission is finished.

One example of where it is particularly effective to transmit on multiple channels is data duplication. Data duplication on multiple sub-channels is used to increase the reliability of transmission. In unlicensed spectrum, data duplication can provide additional robustness against LBT failures. When combining data duplication with NR-U wideband operation, it is required for the transmitter to perform LBT separately on each configured/scheduled sub-channel.

There are different schemes supported for DL/UL channel access for multi-channel transmission denoted Type A and Type B.

In type A: The transmitter performs cat4 LBT independently on multiple sub-channels. Upon successful LBT on a first sub-channel, the transmitter can either transmit on first sub-channel only or defer transmission until LBT is successful on the second, third, etc. sub-channels. In the latter case, the transmitter performs one shot-LBT again on the first sub-channel prior to transmission.
Type A1: LBT counter independently determined for each carrier
Type A2: LBT counter is determined for the carrier that has the largest value of the maximum congestion window. Then the LBT counter for all other carriers is set equal to this value (so that LBT counter is initialized to exact the same value on all carriers).

In type B: the transmitter performs cat4 LBT on one first primary sub-channel (selected by the transmitter at most once every second), or uniformly randomly choosing from the set of carriers before each transmission on multiple carriers. Upon successful LBT on the first primary sub-channel, the transmitter performs one shot-LBT on second, third etc. sub-channels.

With NR-U UL CG (new radio unlicensed uplink configured grant) framework, a UE can be allocated with semi-persistent UL transmission opportunities that can occur as often as every second OFDM (orthogonal frequency division multiplexing) symbol. Assuming SCS (sub carrier spacing) of 60 kHz, this may correspond to a transmission opportunity every ˜35 μs.

In case of adjacent sub-channels, or sub-channels with limited frequency separation, due to practical transceiver implementation issues, while transmitting on one sub-channel, the transmitter can neither perform LBT nor initiate transmission on other sub-channels. So, starting the transmission on the sub-channel that first experiences successful LBT will prevent transmission on other sub-channels during the channel occupancy time.

When a transmitter (e.g. a UE) is to simultaneously transmit URLLC (ultra reliable low latency communication) data on multiple sub-bands (using e.g. repetition/duplication in frequency domain), there is therefore a dilemma as to whether the transmitter should:
initiate transmission on any of the subchannels as soon as at least one subchannel is available for transmission. This may introduce inefficiencies (e.g. only one subchannel used at a time) that may in the long term negatively impact the latency performance, or
defer transmission until all sub-channels are available for transmission. This can obviously impact the latency performance if at least one of the sub-channels experiences LBT blockage. It is also possible that all the sub-channels become busy while self-deferring, causing even more severe problems on the latency.

Looking at one example scenario where a UE is allocated simultaneous UL configured grant transmissions on multiple sub-channels (with repetition/duplication configured in frequency domain):

With Type B multi-carrier channel access the transmitter selects one primary sub-channel where it performs cat4 LBT. The transmitter can perform cat2 LBT on other sub-channels only after the cat4 LBT is successful on the primary sub-channel. The primary sub-channel can be selected at most once every one second, or before each transmission based on a random selection. This option is not suitable for the transmission of data with low latency requirements as LBT blockage on the primary sub-channel will block transmission on all sub-channels.

A UE using Type A LBT may be able to initiate transmission on one sub-channel (#1) while LBT on another sub-channel (#2) is still ongoing. If transmission is initiated in sub-channel #1, then the UE needs to stop LBT on sub-channel #2. In this way, the UE reduces latency but may effectively only transmit on one sub-channel at a time. Where data duplication is being used, besides reducing the reliability of transmission (by transmitting on one sub-channel only), this option may require complicated mechanisms to perform cancelation of duplicates on the sub-channel with no transmission, otherwise the latency may effectively be increased due to (1) transmissions only happening on one sub-channel at a time and (2) unnecessary time-domain multiplexing of data duplicates.

In this regard cat 2 LBT is LBT without random back off. This is a fast LBT which usually has a listening period of 25 microseconds at 5 GHz for example and may be used in multi-channel access. Cat 4 LBT is LBT with random back off with variable sizes contention window. The contention window length depends on the channel access priority class.

FIG. 1 shows example of Type A1 (without self-deferral) multi-carrier access procedure for the transmission of URLLC data using duplication in case interference is experienced on one of the carriers (A), as well as without any interference (B). We assume the transmitter (UE) is allocated UL CG transmission on two channels/carriers. In the example, UL CG resources are allocated with a periodicity of ˜35 μs (corresponding to ca. 4 CCA slots of 9 μs). The example illustrates how, independently of whether the sub-channel #2 is idle or busy, the transmitter (UE) always ends up transmitting only on sub-channel #1 (with the drawbacks highlighted above) as the other sub channel is not available at the same time due to differences in the LBT counters and there is no self deferral to allow the UE to wait for a subsequent channel to be available.

With Type A1 LBT, the transmitter could also perform self-deferral and wait until cat4 LBT is successful on other channels. However, this option presents similar drawbacks as Type B channel access described above in case one of the sub-channels is blocked by interference. This scenario is illustrated in FIG. 2A.

FIG. 2: Example of Type A1 (with self-deferral) multi-carrier access procedure for the transmission of URLLC (ultra reliable low latency communication) data using duplication in case interference is experienced on one of the carriers (A), as well as without any interference (B). In this example the two devices always transmit on the two channels at the same time. The latency that this imposes is indicated by the length of the self deferral time and where one of the channels is busy can introduce significant latency. Thus, in example A where sub channel #2 is busy. Then the LBT counter does not decrement during the busy period and for 4 CCA slots afterwards and thus, there is a significant delay for the two channels to be available. Where both channels are available during the scan shown in B, then the delay on channel #1 occurs due to the difference in LBT counter values. As can be seen a cat 2 LBT is performed after self deferral to confirm that channel #1 is still available.

Another option illustrated in FIG. 3 (Type A2) is to set the LBT counter on different sub-channels to the same value based on the sub-channel with highest value of the maximum contention window. An advantage of this option is that, in the absence of interference on both subchannels, the independent LBT procedures on multiple sub-channels are synchronized and should be successful at the same time (thus avoiding transmitting on single sub-channel where other sub-channels are also free from interference). Still, in the presence of interference on one of the sub-channels, transmission on the sub-channel with no interference may be unnecessarily delayed as the LBT counter is determined based on the sub-channel with largest value of the maximum contention window.

In A of FIG. 3 interference is experienced on one of the carriers (A) and as in this example there is no self deferral, transmission occurs on sub channel #1 and not on scb channel #2. While transmission occurs on sub channel #1 no scanning can occur on sub channel #2 so this transmission is further delayed. In B no interference occurs and the device transmits on both sub channels when the LBT procedure is complete. The LBT procedure takes the same time on both sub channels as the LBT counter has been set to the same value.

To address many of these issues embodiments provide a system where a node on sensing one channel to be available will make an informed decision as to whether to transmit on that channel sooner, or to delay and wait for a further channel to be available in order to be able to transmit on more than one channel together. The decision will be informed by an assessment of when it is expected that one of the other channels will become available and whether that is within a certain set deferral time or not. Where it is then the node will wait and perhaps assess again later. If at any point the node determines that it is unlikely that any other channel will become available within the set deferral time, then it will choose to transmit on the available channel at the next available transmitting opportunity. In this way blocking of a channel should be avoided as if any blocking is detected or estimated to be likely then self deferral will be cancelled.

Embodiments propose a novel multi-carrier LBT (listen before talk) mechanism for URLLC (Ultra Reliable Low Latency Communication) data transmission over unlicensed spectrum with sub-ims latency requirements.

In embodiments, the UE is allocated with a set of UL CG (uplink configured grant) that is uplink transmission opportunities that share the same time domain configuration. The UE is also provided with a packet delay budget (or deferral allowance) for the specific set of UL CG transmissions. The packet delay budget could be configured for the logical channel (LCH) or LCH group which is mapped to the corresponding set of UL CG transmissions. The packet delay budget provides the maximum time that the UE is allowed to defer transmission of a signal. In some embodiment, the packet delay budget is configured as the maximum number of UL CG transmission occasions for which a UE can defer data transmission on a sub-channel following a successful LBT.

The decision as to whether to perform self-deferral may be taken at each UL transmission opportunity depending on (1) the packet delay budget, (2) the value of the LBT counter in other carriers, and (3) the channels status (idle/busy) of other carriers.

The LBT counter N is maintained independently on each carrier (sub-channel #1 and sub-channel #2); Upon the LBT counter N being equal to zero in one of the carriers (sub-channel #1) and the UE being able to initiate transmission on the corresponding carrier; The UE checks the channel status (e.g. whether the carrier was sensed idle or busy in the last CCA slot) and the LBT counter N on the other carriers (sub-channel #2). Based on the channel status and status of the LBT procedure in the additional carriers (sub-channel #2), including the value of the LBT counter N, the UE evaluates whether channel access on at least one of the additional carriers (sub-channel #2) could be successfully completed within the packet delay budget.

If YES, the UE defers data transmission on the carrier where the LBT was successful (sub-channel #1) until the next transmission opportunity

If NO, the UE starts transmission on the carrier(s) where LBT was successful (sub-channel #1).

At the next transmission opportunity the UE may evaluate again as to whether channel access on at least one of the additional carriers (sub-channel #2) could be successfully completed within the packet delay budget.

If YES, the UE defers data transmission on the carrier where the LBT was successful (sub-channel #1) until the next transmission opportunity

If NO, the UE starts transmission on the carrier(s) where LBT was successful (sub-channel #1).

Operation according to one exemplary implementation of the proposed invention is shown in the flow chart of FIG. 4.

In step S10 the UE starts Cat4 LBT procedure on multiple sub-channels and proceeds to scan the multiple channels, including where appropriate using self deferral (S20) until:

the LBT procedure is successful on at least one sub-channel (Ci), that is a valid UL transmission opportunity is found (D5 yes) and when the UE is ready to transmit on at least one carrier (D15—yes), then

firstly the UE determines if there is any other sub-channel that could be used for transmission but where the LBT procedure is yet not successful (D25).

If not (No), the UE initiates transmission on the available sub-channel(s) at step S30.

If yes, the UE checks at D35 whether the channel status is IDLE on at least one of the additional sub-channels (Cj, j≠i)

In one possible implementation a sub-channel is determined to be IDLE if the sub-channel was sensed as IDLE during the last CCA (clear channel assessment) measurement

In an alternative implementation, the sub-channel can be determined as IDLE also if the sub-channel was sensed as BUSY during the last CCA measurement, if e.g. the UE can estimate (based on past measurement samples) that the channel will become IDLE within a certain number of CCA slots.

In yet another implementation, the sub-channel can be determined as BUSY even if the sub-channel was sensed as IDLE during the last CCA measurement, if e.g. the UE can estimate (based on past measurement samples) that the channel will become BUSY within a certain number of CCA slots.

If the channel is BUSY on all other sub-channels (D35 No) or the next UL Tx opportunity is NOT within the packet budget delay (D45 No), then the UE initiates transmission on the sub-channel(s) that are available at step S30.

In one embodiment, the packet delay budget is defined as the maximum number of UL CG transmission occasions, K, for which a UE can defer data transmission on a sub-channel with successful LBT. In this case, the next UL Tx opportunity is NOT within the packet budget delay if e.g. the UE was first ready to transmit on any of the available sub-channels at UL transmission opportunity #n, and the next UL transmission opportunity #n+K+1

Otherwise the UE checks the value of the LBT counter and the status of LBT (e.g. whether the UE is in additional defer mode—D55) on the corresponding sub-channel(s) and estimates the minimum time before the UE can complete successful cat4 procedure at steps S40 and S50 depending where UE is in the deferral period.

If it is determined that this time is within the packet delay budget for at least one of the additional sub-channels at D65, then the UE defers transmission until the next UL transmission opportunity and proceeds to scan the other channels by returning to step S20.

Otherwise the UE initiates transmission on the available sub-channel(s) at step S30.

FIG. 5 shows the timings of the transmission according to an embodiment where interference is experienced and where there is no interference. In this example when sub channel #1 is available and there is a transmission opportunity sub channel #2 is busy, the UE determines that the LBT counter of sub channel #2 is set to 10 and that the channel is currently busy and in this case determines from this that it is unlikely that the sub channel #2 will become available and have a transmission opportunity in the packet delay budget for the UE and thus it transmits a signal on subchannel #1 at the first available transmission opportunity.

In the second example there is no interference and when sub channel #1 becomes available the UE determines the LBT counter in subchannel #2 is at 8 and that the channel is idle and it determines that the channel is likely to have a transmission opportunity within the packet delay budget and thus, it defers transmission on sub channel #1 until sub channel #2 is available and the two channels are used to transmit signals together.

The advantages of the proposed channel access method as compared to prior art solutions is illustrated in FIG. 5. The proposed method combines the advantages of type A2 channel access (synchronized channel access in case of no or limited interference on one of the channels) with those of type A1 without self-deferral (fast channel access in case of interference on one of the channels).

FIG. 6 illustrates an apparatus or node according to an embodiment. The apparatus 10 is configured to transmit and receive signals on multiple channels within the unlicensed spectrum, shown schematically as double sided arrow 22, and may for example be a user equipment or a gNB. Apparatus 10 comprises transmit circuitry 30 and receive circuitry 32 which are configured to transmit and receive signals on multiple channels of the unlicensed spectrum via antenna 20. The apparatus 10 comprises scanning circuitry 40 configured to scan the multiple channels in the unlicensed spectrum using a listen before talk procedure to determine whether they are available. In other embodiments other scanning circuitry that uses other scanning procedures such as a clear channel assessment may be used.

Apparatus 10 comprises control circuitry 50 that is configured to control the transmit, receive and scanning circuitry 30, 32, 40 to perform a method such as that illustrated in FIG. 4 whereby the apparatus transmits signals, perhaps duplicate signals towards at last one further node on one or more channels within the unlicensed spectrum. The apparatus scans multiple channels in unlicensed spectrum to determine at least one channel that is available. On detecting an available channel and prior to transmitting a signal on that channel it determines whether another of the multiple scanned channels is likely to become available within a predetermined packet delay budget. Where not, then it transmits a signal at the first transmitting opportunity. Where so, then it waits for the next transmitting opportunity while continuing to scan the other channels and then makes the same assessment again.

The packet delay budget may be set for a particular device, type of communication, or channel. It may be set centrally by the network or may be user equipment specific. It may be set as a time value, or as a counter value, the counter value may indicate a number of transmission opportunities. The network node may be configured to transmit the packet delay budget or deferral allowance to a user equipment. The network node may also transmit an indication that data duplication is to be used and/or a type of listen before talk that is to be used. The user equipment may comprise means configured to receive the deferral allowance signal and in response to set the deferral allowance accordingly. It may be set for a given set of uplink configured grants and could be configurable by a network node. The determination as to whether to defer transmission and as to whether or not a further channel is likely to become available in the packet delay budget may also be configurable and may depend on the current value of the LBT counter, the current availability, the historical availability and current channel loading and/or occupancy.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus comprising:
at least one processor; and
at least one memory including computer program code, said at least one memory and computer program code being configured to, with said at least one processor, cause the apparatus at least to:
initiate scanning of a plurality of channels in unlicensed spectrum to determine whether said plurality of channels are available;
determine a transmitting opportunity at which said apparatus is able to transmit a signal on at least one channel sensed to be available during said scanning;
estimate at least one further transmitting opportunity when it is estimated that said apparatus may be able to transmit a signal on at least one other channel in unlicensed spectrum; and
ascertain whether a delay between said transmitting opportunity and said at least one further transmitting opportunity lies within a current deferral allowance for said apparatus, said deferral allowance comprising a maximum period that said apparatus may defer said transmission; and where not
control transmission of a signal on said at least one available channel; and where so
wait for one of said at least one further transmitting opportunities that lie within said current deferral allowance before controlling transmission of at least one signal on said at least one available channel.

2. The apparatus according to claim 1, wherein said at least one memory and said computer program code being configured to, with said at least one processor, cause the apparatus at least to estimate a time of said at least one further transmitting opportunity for said at least one channel from at least one of: a determined status of said channel and a backoff time associated with said channel, said backoff time being a minimum time delay before a transmitting opportunity can occur if said channel is currently and remains idle.

3. The apparatus according to claim 2, wherein said determined status of said channel comprises one of: a sensed status sensed during a previous measurement time period, or an estimated status based on said sensed status and historical availability of said channel.

4. The apparatus according to claim 3, wherein said previous measurement time period comprises a measurement period immediately preceding a most recent transmitting opportunity.

5. The apparatus according to claim 1, wherein said at least one memory and said computer program code being configured to, with said at least one processor, cause the apparatus at least to determine if any of said at least one other of said multiple channels is available at one of said at least one further transmitting opportunities and where so said means is configured to control transmitting said at least one signal on said at least one available channel and at least one further signal on said at least one other available channel at said one of said at least one further transmitting opportunities.

6. The apparatus according to claim 1, wherein said at least one memory and said computer program code being configured to, with said at least one processor, cause the apparatus at least to determine whether all of said at least one other of said multiple channels are busy and where so to control transmission of said at least one signal on said at least one available channel at a next transmitting opportunity.

7. The apparatus according to claim 1, wherein said at least one signal and said at least one further signal are a same signal, and wherein said at least one memory and said computer program code being configured to, with said at least one processor, cause the apparatus at least to transmit duplicate signals on multiple channels.

8. The apparatus according to claim 1, wherein said apparatus comprises a user equipment.

9. The apparatus according to claim 1, wherein said at least one memory and said computer program code being configured to, with said at least one processor, cause the apparatus at least to receive a signal from a network node indicative of said deferral allowance.

10. The apparatus according to claim 1, wherein said apparatus comprises a gNB.

11. The apparatus according to claim 1, wherein said one or more signals comprise downlink signals.

12. (canceled)

13. The apparatus according to claim 1, said apparatus further comprising transmit circuitry configured to transmit signals, receive circuitry configured to receive signals, and scan circuitry configured to scan channels in unlicensed spectrum.

14. A method comprising:
scanning a plurality of channels in unlicensed spectrum to determine whether said plurality of channels are available;
in response to determining at least one of said plurality of channels is available determining a transmitting opportunity at which an apparatus is able to transmit at least one signal on said at least one available channel;
estimating at least one delay between said transmitting opportunity and at least one further transmitting opportunity at which it is estimated that said apparatus may be able to transmit a signal on at least one other of said plurality of channels; and
determining whether any of said at least one delays lie within a current deferral allowance, said deferral allowance comprising a maximum period that said apparatus may defer said transmission, and where not
transmitting said at least one signal on said at least one available channel; and
where so
delaying transmitting said at least one signal on said at last one available channel until a further transmitting opportunity within said current deferral allowance.

15. The method according to claim 14,
wherein said estimating said at least one delay comprises estimating a time of said at least one further transmitting opportunity for said at least one channel from at least one of: a determined status of said channel and a backoff time associated with said channel, said backoff time being a minimum time delay before a transmitting opportunity can occur if said channel is currently and remains idle.
a determined status of said channel

[symbol]

16. The method according to claim 15, wherein said determined status of said channel comprises one of: a sensed status sensed during a previous measurement time period, or an estimated status based on said sensed status and historical availability of said channel.

17. The method according to claim 14, said method further comprising determining if any of said at least one other of said plurality of channels is available at one of said at least one further transmitting opportunities and where so
controlling said transmitting means to transmit said at least one signal on said at least one available channel and said at least one further signal on said at least one other available channel at said further transmitting opportunity.

18. The method according to claim 14, said method further comprising determining whether all of said at least one other of said plurality of channels are busy and where so controlling said transmitting means to transmit said at least one signal on said at least one available channel at a next transmitting opportunity.

19. The method according to claim 14, wherein said at least one signal and said at least one further signal are a same signal, said method transmitting duplicate signals on multiple channels where multiple channels are available.

20. A computer program comprising computer readable instructions which when executed by a processor on an apparatus are operable to control said apparatus to perform a method according to claim 14.
